(19) United States
(12) Patent Application Publication
(10) Pub. No.: US 2025/0083042 A1
(43) Pub. Date: Mar. 13, 2025

(54) VIRTUAL EXPERIENCES WITH DIFFERENT VIEWING MODES

(71) Applicant: Roblox Corporation, San Mateo, CA (US)

(72) Inventors: David B. BASZUCKI, Portola Valley, CA (US); Joseph REESE, San Mateo, CA (US); Sang HAN, San Mateo, CA (US); Brina LEE, San Mateo, CA (US); Garima SINHA, San Mateo, CA (US)

(73) Assignee: Roblox Corporation, San Mateo, CA (US)

(21) Appl. No.: 18/435,695

(22) Filed: Feb. 7, 2024

Related U.S. Application Data
(60) Provisional application No. 63/537,032, filed on Sep. 7, 2023.
(60) Provisional application No. 63/537,036, filed on Sep. 7, 2023.
(60) Provisional application No. 63/548,352, filed on Nov. 13, 2023.

(51) Int. Cl. A63F 13/525; G06T 13/20; G06T 15/20

(52) U.S. Cl. CPC A63F 13/525; G06T 13/20; G06T 15/20; G06T 2200/24

(57) ABSTRACT

A metaverse application places a first avatar of a first player at a first position and a second avatar of a second player at a second position in a virtual experience. The metaverse application determines a bias direction based on the first position and the second position. The metaverse application determines a bias offset based on the bias direction, the first position, and the second position. The metaverse application a camera position of a virtual camera in the virtual experience based on the bias offset. The metaverse application presents a field of view of a third player in cinematic mode based on the camera position of the virtual camera.

### CROSS-REFERENCE TO RELATED APPLICATIONS

The present application claims priority to U.S. Provisional Patent Application No. 63/548,352, filed on Nov. 13, 2023 and titled “Virtual Experiences with Different Viewing Modes;” U.S. Provisional Patent Application No. 63/537,032, filed on Sep. 7, 2023 and titled “View Modes for a Call Conducting During a Virtual Experience;” and U.S. Provisional Patent Application No. 63/537,036, filed on Sep. 7, 2023 and titled “Camera Operator for a Call Conducted During a Virtual Experience,” the contents of each of which are incorporated by reference herein in their entirety.

### TECHNICAL FIELD

This disclosure relates generally to communications and computer graphics, and more particularly but not exclusively, relates to methods, systems, and computer readable media to enable transitions between modes and views in a virtual experience.

### BACKGROUND

A virtual environment is a simulated three-dimensional environment generated from graphical data. Users may be represented within the virtual environment in graphical form by an avatar. The avatar may interact with other users through corresponding avatars, move around in the virtual experience, or engage in other activities or perform other actions within the virtual experience.

When virtual experiences are represented with a field of view to illustrate a first-person perspective while a player moves within the virtual experience, the player may experience nausea and dizziness based on a dissonance between experiencing little or no motion of their physical body and viewing a display that illustrates movement. In addition, the player may experience eye strain if the other avatars are too small or too close.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Embodiments relate generally to a system and method to determine a field of view of a player in cinematic mode in a virtual experience. In some embodiments, a method includes placing a first avatar of a first player at a first position and a second avatar of a second player at a second position in a virtual experience. The method further includes determining a bias direction based on the first position and the second position. The method further includes determining a bias offset based on the bias direction, the first position, and the second position. The method further includes determining a camera position of a virtual camera in the virtual experience based on the bias offset. The method further includes presenting a field of view of a third player in cinematic mode based on the camera position of the virtual camera.

In some embodiments, determining the bias offset is further based on a first vector between the first position and the second position, a second vector that is perpendicular to the first vector, and an addition of a bias to front subject vector to the second vector. In some embodiments, the method further includes determining that a distance between the virtual camera and the first avatar is below a distance threshold and in response to the determining, updating the field of view based on a fourth position of the virtual camera, wherein the field of view switches from capturing a front view to a shoulder view that captures the first avatar and the second avatar from a perspective of being over a shoulder of the third player. In some embodiments updating the field of view to switch from capturing the front view to the shoulder view is further based on a weight, wherein the weight is based on a ratio of a difference between a maximum distance threshold and a distance between the virtual camera and the first avatar and the maximum distance threshold. In some embodiments, updating the field of view to switch from capturing the front view to the shoulder view is further based on a shoulder view weight that is based on the weight and an aspect ratio of the virtual camera.

In some embodiments, the method further includes determining to transition from the cinematic mode to a second mode and determining a start frame associated with the cinematic mode, an end frame associated with the second mode, and interpolating between the start frame and the end frame. In some embodiments, interpolating between a position of the start frame and a position of the end frame includes applying a Catmull-Rom spline.

In some embodiments, the method further includes setting an initial position and initial rotation values for a virtual spring that is associated with the virtual camera and simulating motion of the virtual camera based on the virtual spring moving from the initial position to a target position, the target position being based on movement of the first avatar and the second avatar, wherein the virtual spring is configured to simulate a dampening of movement of the virtual camera and a speed of rotation of the virtual camera. In some embodiments, the method further includes setting an initial position and initial rotation values for a virtual spring that is associated with the virtual camera and simulating rotation of the virtual camera based on the virtual spring from an initial direction to a target direction while keeping the first avatar and the second avatar visible in the field of view, wherein the virtual spring is configured to simulate a dampening of movement of the virtual camera and a speed of rotation of the virtual camera. In some embodiments, the method further includes setting an initial position and initial rotation values for a virtual spring that is associated with the virtual camera and simulating motion of the virtual camera based on the virtual spring to change a field of view of the virtual camera, wherein the virtual spring is configured to simulate a dampening of movement of the virtual camera and a speed of rotation of the virtual camera. In some embodiments, the method further includes responsive to determining that, after movement of the first avatar within the virtual experience, a distance between the camera position of the virtual camera and a third position associated with the first avatar exceeds a distance threshold, presenting the field of view of the third player based on an updated position of the virtual camera, wherein a distance between the updated position and the third position is less than a distance between the camera position and the third position. In some embodiments, the method further includes prior to presenting the field of view in the cinematic mode, generating graphical data of a user interface that includes a button that, when selected, causes the virtual experience to be displayed in the cinematic mode.

In some embodiments, a system includes a processor and a memory coupled to the processor, with instructions stored thereon that, when executed by the processor, cause the processor to perform operations comprising: placing a first avatar of a first player at a first position and a second avatar of a second player at a second position in a virtual experience; determining a bias direction based on the first position and the second position; determining a bias offset based on the bias direction, the first position, and the second position; determining a camera position of a virtual camera in the virtual experience based on the bias offset; and presenting a field of view of a third player in cinematic mode based on the camera position of the virtual camera.

In some embodiments, the operations further include determining that a distance between the virtual camera and the first avatar is below a distance threshold and in response to the determining, updating the field of view based on a fourth position of the virtual camera, wherein the field of view switches from capturing a front view to a shoulder view that captures the first avatar and the second avatar from a perspective of being over a shoulder of the third player. In some embodiments, the operations further include determining to transition from the cinematic mode to a second mode and determining a start frame associated with the cinematic mode, an end frame associated with the second mode, and interpolating between the start frame and the end frame. In some embodiments, the methods further include setting an initial position and initial rotation values for a virtual spring that is associated with the virtual camera and simulating motion of the virtual camera based on the virtual spring moving from the initial position to a target position, the target position being based on movement of the first avatar and the second avatar, wherein the virtual spring is configured to simulate a dampening of movement of the virtual camera and a speed of rotation of the virtual camera.

In some embodiments, non-transitory computer-readable medium with instructions that, when executed by one or more processors at a computing device, cause the one or more processors to perform operations, the operations comprising: placing a first avatar of a first player at a first position and a second avatar of a second player at a second position in a virtual experience; determining a bias direction based on the first position and the second position; determining a bias offset based on the bias direction, the first position, and the second position; determining a camera position of a virtual camera in the virtual experience based on the bias offset; and presenting a field of view of a third player in cinematic mode based on the camera position of the virtual camera.

In some embodiments, the operations further include determining that a distance between the virtual camera and the first avatar is below a distance threshold and in response to the determining, updating the field of view based on a fourth position of the virtual camera, wherein the field of view switches from capturing a front view to a shoulder view that captures the first avatar and the second avatar from a perspective of being over a shoulder of the third player. In some embodiments, the operations further include determining to transition from the cinematic mode to a second mode and determining a start frame associated with the cinematic mode, an end frame associated with the second mode, and interpolating between the start frame and the end frame. In some embodiments, the methods further include setting an initial position and initial rotation values for a virtual spring that is associated with the virtual camera and simulating motion of the virtual camera based on the virtual spring moving from the initial position to a target position, the target position being based on movement of the first avatar and the second avatar, wherein the virtual spring is configured to simulate a dampening of movement of the virtual camera and a speed of rotation of the virtual camera.

### BRIEF DESCRIPTION OF THE DRAWINGS

FIG. 1 includes example graphics of a problematic view, a front view in cinematic mode, and a shoulder view in cinematic mode, according to some embodiments described herein.

FIG. 2 is a block diagram of an example network environment, according to some embodiments described herein.

FIG. 3 is a block diagram of an example computing device, according to some embodiments described herein.

FIG. 4 includes an example diagram used to determine a camera position of a virtual camera based on a bias direction, a bird's eye perspective of a virtual experience, and a first-player perspective of a portrait front view in cinematic mode, according to some embodiments described herein.

FIG. 5 includes an example diagram used to determine the camera position and

direction and a player perspective of a landscape front view in cinematic mode, according to some embodiments described herein.

FIG. 6 includes an example diagram of a virtual experience with a danger zone, a graphic with portions of the diagram superimposed on the virtual experience, and a graphic of a player perspective shoulder view in cinematic mode, according to some embodiments described herein.

FIG. 7 includes example graphics that illustrate a shoulder view with a right offset as compared to a shoulder view with a left offset, according to some embodiments described herein.

FIG. 8 includes an example diagram of shoulder view parameters in a virtual experience and graphics of corresponding shoulder views as a function of weight, according to some embodiments described herein.

FIG. 9 includes example graphics of a cinematic mode and a picture-in-picture mode, according to some embodiments described herein.

FIG. 10 is a flow diagram of an example method to determine a field of view of a player in cinematic mode in a virtual experience, according to some embodiments described herein.

### DETAILED DESCRIPTION

Virtual experiences enable a plurality of players, each with an associated avatar, to participate in activities such as collaborative gameplay (playing as a team), competitive gameplay (one or more users playing against other users, or teams of users competing), virtual meetups (e.g., interactive calling within a virtual experience, birthday parties, meetings within a virtual experience setting, concerts, or other kinds of events where two or more avatars are together at a same location within a virtual experience). When participating together in a virtual experience, players are provided with views of the setting within the virtual experience, e.g., a campfire, a meeting room, etc. Players can view their own avatar and/or the avatars belonging to other players within the virtual experience, each avatar being at a respective position within the virtual experience.

As avatars move about within the virtual experience, they may move too far from a player for the facial expressions and/or gestures made with arms to be viewable for the player. On the other hand, if two avatars are close to each other, a view of the full body of the avatar may not be available. Thus, providing appropriate views that keep an avatar at a viewable distance and in visual range of a viewing avatar is useful to provide a satisfactory virtual experience.

Techniques are described herein to automatically select a viewing mode and/or to adjust the position and/or orientation of a virtual camera that generates a view of the virtual experience to provide a satisfactory viewing experience. To determine the mode, distances between the participating avatars as well as the distance between a virtual camera and one or more of the avatars may be determined and compared to a threshold distance.

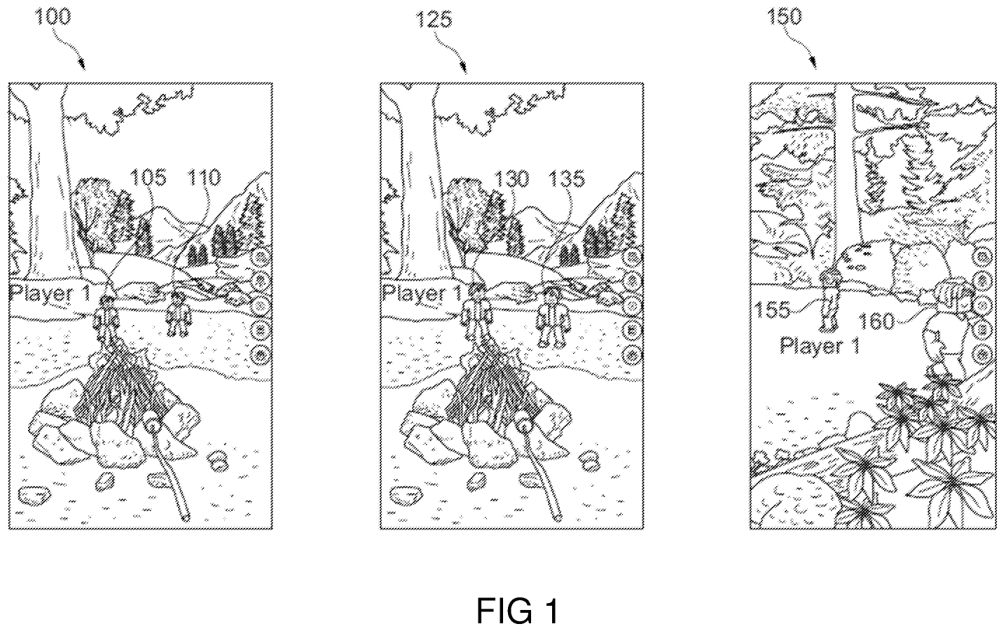

During first-person gameplay in a virtual experience, there are many factors that cause the virtual experience to be unpleasant for a user. For example, FIG. 1 illustrates an example graphic 100 of a field of view for a player that includes two avatars 105, 110. The avatars 105, 110 are too small to be comfortably perceived by the user. In addition, when the user moves in the virtual experience, movement in the virtual experience may be simulated with a virtual camera that mimics movement by rotating too quickly while trying to keep the other avatars in the user's field of view. As a result, the user may experience eye strain and nausea. In addition, the user may spend less time interacting with the virtual experience or stop playing altogether.

The technology described herein advantageously solves the problem of a user that experiences eye strain and nausea by using a metaverse application (virtual environment application) that generates graphical data that displays a field of view of a user from a first-person perspective that includes avatars that are a larger size. The metaverse application provides multiple options for different views to improve the user experience. For example, cinematic mode allows the user to interact with avatars in the virtual experience as if the user were inside the world (inside the virtual experience). The metaverse application displays the avatars using a bias offset to ensure that a virtual camera displays a field of view from a middle position of the avatars, which prevents awkward transitions between a front view and other views, such as a shoulder view.

The metaverse application changes views within the cinematic mode based on the position of the user and the avatars. For example, the metaverse application may determine when a distance between the user and an avatar falls below a distance threshold, the metaverse application switches from a front view as illustrated in the example graphic 125 of FIG. 1 to a shoulder view as illustrated in the example graphic 150 of FIG. 1. Switching views results in the avatars 130, 135 in graphic 125 and the avatars 155, 160 in graphic 150 being maintained at sizes that avoid eye strain as compared to the avatars 105, 110 in the original graphic 100.

The metaverse application provides options to switch to other modes. For example, the metaverse application may switch from the cinematic mode to a picture-in-picture mode, which simulates a user that is in a video call with an avatar in the virtual experience. When the metaverse application switches between modes, the metaverse application advantageously determines a start frame associated with the cinematic mode, an end frame associated with the other mode, and interpolates between the start frame and the end frame to ensure that the transition between frames is not disorienting to the user.

### Example Environment 200

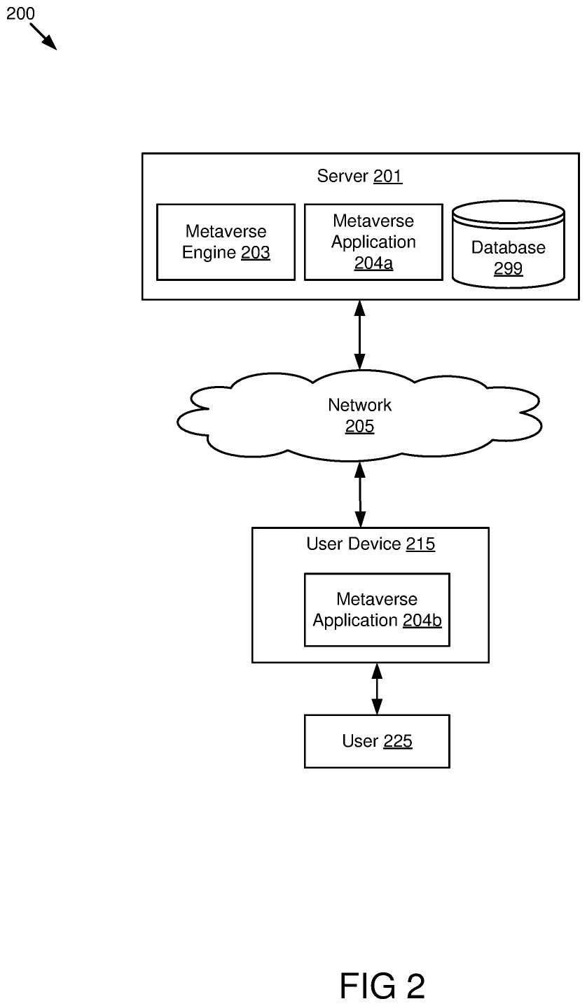

FIG. 2 illustrates a block diagram of an example environment 200. In some embodiments, the environment 200 includes a server 201 and user device 215, coupled via a network 205. User 225 may be associated with the user device 215. In some embodiments, the environment 200 may include other servers or devices not shown in FIG. 2. For example, the server 201 may include multiple servers 201 and the user device 215 may include multiple user devices 215a, n. In FIG. 2 and the remaining figures, a letter after a reference number, e.g., “215a,” represents a reference to the element having that particular reference number. A reference number in the text without a following letter, e.g., “215,” represents a general reference to embodiments of the element bearing that reference number.

The server 201 includes one or more servers that each include a processor, a memory, and network communication hardware. In some embodiments, the server 201 is a hardware server. The server 201 is communicatively coupled to the network 205. In some embodiments, the server 201 sends and receives data to and from the user device 215. The server 201 may include a metaverse engine 203, a metaverse application 204a, and a database 299.

In some embodiments, the metaverse engine 203 includes code and routines operable to generate and provide a metaverse, such as a three-dimensional (3D) virtual environment. The virtual environment may include one or more virtual experiences in which one or more users can participate as an avatar. An avatar may wear any type of outfit, perform various actions, and participate in gameplay or other types of interaction with other avatars. Further, a user associated with an avatar may communicate with other users in the virtual experience via text chat, voice chat, video (or simulated video) chat, etc. In some embodiments where a user interacts with a virtual experience in a first-person game, the display for the user does not include the user's avatar. However, the user's avatar is visible to other users in the virtual environment.

Virtual experiences may be generated by the metaverse application 204a. Virtual experiences in the metaverse/virtual environment may be user-generated, e.g., by creator users that design and implement virtual spaces within which avatars can move and interact. Virtual experiences may have any type of objects, including analogs of real-world objects (e.g., trees, cars, roads) as well as virtual-only objects.

The metaverse application 204a may generate a virtual experience that is particular to a user 225. In some embodiments, the metaverse application 204a on the server 201 receives user input from the metaverse application 204b stored on the user device 215, updates the virtual experience based on the user interface, and transmits the updates to other user devices 215b, n.

In some embodiments, the metaverse engine 203 and/or the metaverse application 204a are implemented using hardware including a central processing unit (CPU), a field-programmable gate array (FPGA), an application-specific integrated circuit (ASIC), any other type of processor, or a combination thereof. In some embodiments, the metaverse engine 203 and/or the metaverse application 204a are implemented using a combination of hardware and software.

The database 299 may be a non-transitory computer readable memory (e.g., random access memory), a cache, a drive (e.g., a hard drive), a flash drive, a database system, or another type of component or device capable of storing data. The database 299 may also include multiple storage components (e.g., multiple drives or multiple databases) that may also span multiple computing devices (e.g., multiple server computers). The database 299 may store data associated with the virtual experience hosted by the metaverse engine 203.

The user device 215 may be a computing device that includes a memory and a hardware processor. For example, the user device 215 may include a mobile device, a tablet computer, a desktop computer, a mobile telephone, a wearable device, a head-mounted display, a mobile email device, a portable game player, a virtual reality (VR) device (e.g., glasses, a headset, gloves, etc.), an augmented reality (AR) device, a portable music player, a game console, or another electronic device capable of accessing a network 205.

The user device 215 includes metaverse application 204b. In some embodiments, the metaverse application 204b places a first avatar of a first player at a first position and a second avatar of a second player at a second position in a virtual experience. The metaverse application 204b determines a bias direction based on the first position and the second position. The metaverse application 204b determines a bias offset based on the bias direction, the first position, and the second position. The metaverse application 204b determines a camera position of the virtual camera based on the bias offset. The metaverse application 204b presents the field of view of the third player in cinematic mode based on the camera position of the virtual camera.

In the illustrated embodiment, the entities of the environment 200 are communicatively coupled via a network 205. The network 205 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof. Although FIG. 2 illustrates one network 205 coupled to the server 201 and the user device 215, in practice one or more networks 205 may be coupled to these entities.

### Example Computing Device 300

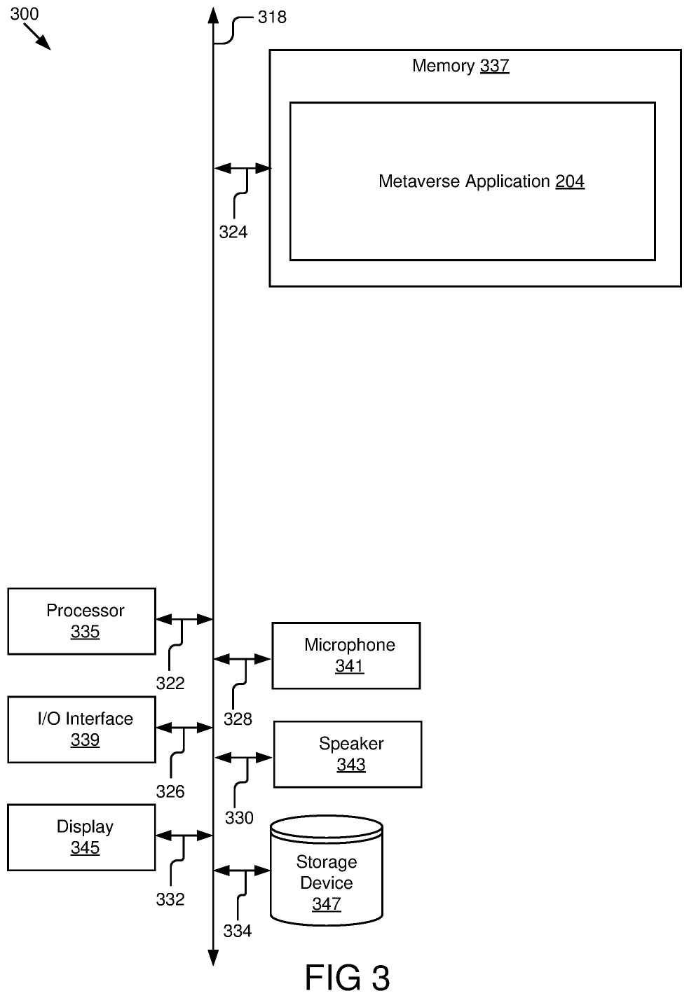

FIG. 3 is a block diagram of an example computing device 300 that may be used to implement one or more features described herein. Computing device 300 can be any suitable computer system, server, or other electronic or hardware device. In some embodiments, the computing device 300 is the user device 215. In some embodiments, the computing device 300 is the server 201.

In some embodiments, computing device 300 includes a processor 335, a memory 337, an Input/Output (I/O) interface 339, a microphone 341, a speaker 343, a display 345, and a storage device 347, all coupled via a bus 318. In some embodiments, the computing device 300 includes additional components not illustrated in FIG. 3. In some embodiments, the computing device 300 includes fewer components than are illustrated in FIG. 3. For example, in instances where the metaverse application 204 is stored on the server 201 in FIG. 2, the computing device may not include a microphone 341, a speaker 343, or a display 345.

The processor 335 may be coupled to a bus 318 via signal line 322, the memory 337 may be coupled to the bus 318 via signal line 324, the I/O interface 339 may be coupled to the bus 318 via signal line 326, the microphone 341 may be coupled to the bus 318 via signal line 328, the speaker 343 may be coupled to the bus 318 via signal line 330, the display 345 may be coupled to the bus 318 via signal line 332, and the storage device 347 may be coupled to the bus 318 via signal line 334.

Processor 335 can be one or more processors and/or processing circuits to execute program code and control basic operations of the computing device 300. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 337 is typically provided in computing device 300 for access by the processor 335, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 335 and/or integrated therewith. Memory 337 can store software operating on the server 201 by the processor 335, including an operating system, software application and associated data. In some implementations, the applications can include instructions that enable processor 335 to perform the functions described herein. In some implementations, one or more portions of metaverse application 204 may be implemented in dedicated hardware such as an application-specific integrated circuit (ASIC), a programmable logic device (PLD), a field-programmable gate array (FPGA), a machine learning processor, etc. In some implementations, one or more portions of the metaverse application 204 may be implemented in general purpose processors, such as a central processing unit (CPU) or a graphics processing unit (GPU). In various implementations, suitable combinations of dedicated and/or general purpose processing hardware may be used to implement the metaverse application 204.

For example, the metaverse application 204 stored in memory 237 can include instructions for retrieving user data, for displaying/presenting avatars, and/or other functionality or software. Any of the software in memory 237 can alternatively be stored on any other suitable storage location or computer-readable medium. In addition, memory 237 (and/or other connected storage device(s)) can store instructions and data used in the features described herein. Memory 237 and any other type of storage (magnetic disk, optical disk, magnetic tape, or other tangible media) can be considered “storage” or “storage devices.”

I/O interface 339 can provide functions to enable interfacing the computing device 300 with other systems and devices. Interfaced devices can be included as part of the computing device 300 or can be separate and communicate with the computing device 300. For example, network communication devices, storage devices (e.g., memory 337 and/or storage device 347), and input/output devices can communicate via I/O interface 339. In another example, the I/O interface 339 can receive data from the server 201 and deliver the data to the metaverse application 204 and components of the metaverse application 204, such as the metaverse application 204. In some embodiments, the I/O interface 339 can connect to interface devices such as input devices (keyboard, pointing device, touchscreen, microphone 341, sensors, etc.) and/or output devices (display 345, speaker 343, etc.).

Some examples of interfaced devices that can connect to I/O interface 339 can include a display 345 that can be used to display content, e.g., images, video, and/or a user interface of the metaverse as described herein, and to receive touch (or gesture) input from a user. Display 345 can include any suitable display device such as a liquid crystal display (LCD), light emitting diode (LED), or plasma display screen, cathode ray tube (CRT), television, monitor, touchscreen, three-dimensional display screen, a projector (e.g., a 3D projector), or other visual display device.

The microphone 341 includes hardware, e.g., one or more microphones that detect audio spoken by a person. The microphone 341 may transmit the audio to the metaverse application 204 via the I/O interface 339.

The speaker 343 includes hardware for generating audio for playback. In some embodiments, the speaker 343 may include audio hardware that supports playback via an external, separate speaker (e.g., wired or wireless headphones, external speakers, or other audio playback device) that is coupled to the computing device 300.

The storage device 347 stores data related to the metaverse application 204. For example, the storage device 347 may store a user profile associated with a user, etc. In some embodiments where the computing device 300 is the metaverse application 204a stored on the server 201, the storage device 347 may be the same as the database 299 of FIG. 2.

### Example Metaverse Application 304

FIG. 3 illustrates a computing device 300 that executes an example metaverse application 204. The metaverse application 204 generates graphical data for displaying a virtual experience.

In some embodiments, before a user participates in the virtual experience, the metaverse application 204 generates a user interface that includes information about how the user's information may be collected, stored, and/or analyzed. For example, the user interface requires the user to provide permission to use any information associated with the user. The user is informed that the user information may be deleted by the user, and the user may have the option to choose what types of information are provided for different uses. The use of the information is in accordance with applicable regulations and the data is stored securely. Data collection is not performed in certain locations and for certain user categories (e.g., based on age or other demographics), the data collection is temporary (i.e., the data is discarded after a period of time), and the data is not shared with third parties. Some of the data may be anonymized, aggregated across users, or otherwise modified so that specific user identity cannot be determined.

In some embodiments, the metaverse application 204 generates different modes for viewing a virtual experience. For example, the metaverse application 204 may generate graphical data for displaying a cinematic mode that keeps avatars within a boundary of a virtual experience in view. In some embodiments, the metaverse application 204 generates a user interface that includes a button that, when selected, causes the virtual experience to be displayed in cinematic mode. The user interface may include other buttons as well, such as a button to switch from a cinematic mode to a picture-in-picture mode.

In some embodiments, the metaverse application 204 uses a virtual camera for cinematic mode to simulate a field of view of the player within the virtual experience where the virtual camera may move upwards up to 45 degrees and from a top view may rotate 180 degrees. Although the examples below are described with reference to a virtual experience where a player is not visible within the field-of-view (except for portions of the player, such as an arm or a leg) and the virtual experience includes a first avatar and a second avatar, the virtual experience may include variations where more of the player is visible and additional avatars are included.

The cinematic mode may support different views, such as a front view and a shoulder view. In some embodiments, the front view uses a bias offset to keep a virtual camera positioned on one side of the virtual experience. The front view may also show avatars as being positioned side-by-side. The shoulder view includes a first avatar as located over-the-shoulder of a second avatar (or a second avatar as over-the-shoulder of a first avatar).

The cinematic mode may support different perspectives including one or more of a close-up perspective, a medium perspective, a wide-angle perspective, and a free-play perspective. The close-up perspective may include a portion of one or more avatars, such as the avatars from the waist to the head. The medium perspective may include the entire body of one or more avatars. The wide-angle perspective may include the entire body of one or more avatars as well as more of the virtual experience as compared to the medium view. The free-play perspective may be used while the player is moving within the virtual experience.

The metaverse application 204 generates graphical data for displaying a virtual experience and places avatars within the virtual experience. The metaverse application 204 a first avatar of a first player at a first position and a second avatar of a second player at a second position in the virtual experience. The field of view of the player in a first-person game may be described using a virtual camera that provides the field of view for the player. The virtual camera is associated with a position and rotation.

In some embodiments, instead of displaying the field of view directly from the location of the virtual camera in the virtual experience, the metaverse application 204 may determine a bias direction based on the first position and the second position. The metaverse application 204 may determine a bias offset based on the bias direction, the first position, and the second position.

The metaverse application 204 may determine a camera position of a virtual camera in the virtual experience based on the bias offset, wherein the camera position represents a field of view of a third player in the virtual experience. The metaverse application 204 may present the field of view of the third player in cinematic mode based on the camera position of the virtual camera.

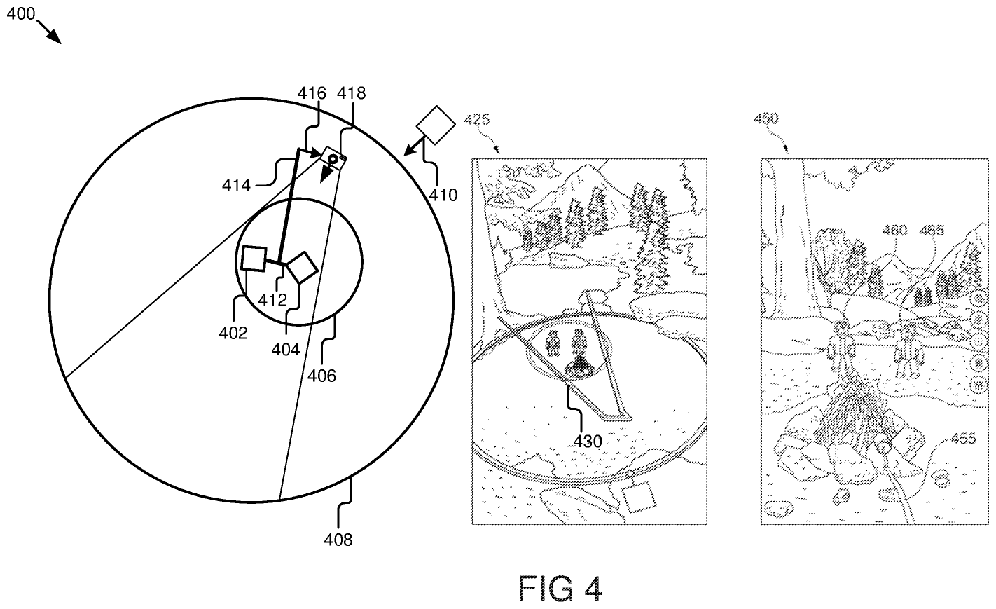

Turning to FIG. 4, an example diagram 400 used to determine a camera position of a virtual camera based on a bias direction, a bird's eye perspective of a virtual experience, and a first-player perspective of a portrait front view in cinematic mode are illustrated.

The example diagram 400 includes a first position 402 of a first avatar and a second position 404 of a second avatar. The first avatar and the second avatar are within a first boundary 406. In some embodiments, the metaverse application 204 illustrates the virtual environment in portrait front view when the first avatar and the second avatar are inside the first boundary. If one or more of the avatars are outside the first boundary 406, the metaverse application 204 may switch to shoulder view. The outer circle is an environment boundary 408 that represents the part of the virtual experience that is visible as part of the field of view of the player.

The metaverse application 204 determines a bias direction 410. The bias direction 410 meets the midpoint of a first line 412 between the first position 402 of the first avatar and the second position 404 of the second avatar. In some embodiments, the bias direction 410 bisects the environment boundary 408 and is pointed in a direction towards the faces of the first avatar and the second avatar.

The metaverse application 204 generates a second line 414 that is perpendicular to the first line 412 between the first position 402 of the first avatar and the second position 404 of the second avatar. A bias offset 416 is applied from the second line 414. The direction for the bias offset 416 is based on moving in the direction of the bias direction 410. The extent of bias offset 416 represents the camera position 418 of the virtual camera.

The first graphic 425 illustrates a bird's eye perspective of the virtual experience where the lines and circles from the diagram 400 are overlaid on the virtual experience in the first graphic 425 including the field of view 430 from the virtual camera. The metaverse application 204 advantageously places the virtual camera at the camera position to keep the field of view directed towards one side of the virtual experience, which prevents awkward camera transitions and resulting nausea.

The metaverse application 204 may present the field of view of the third player based on the camera position 418 of the virtual camera in the example diagram 400. The second graphic 450 is a first-player perspective of a portrait front view in a cinematic mode of the virtual experience. Although the body of the player may not be visible in the virtual experience, graphics may be used to provide indicators that the player is present in the virtual experience, such as the stick 455 with a marshmallow attached indicating that the player is participating in campfire activities with the two avatars 460, 465. In some embodiments, parts of the avatar of the player may be visible depending on the angle of the virtual camera, such as if a player extends an arm into the virtual experience. In some embodiments, this also depends on the type of computing device 300. For example, more of the player's body may be visible if the computing device includes a VR headset and gloves.

In some embodiments, the metaverse application 204 uses coordinate frames, CFrames, and various calculations to determine the bias offset for determining the field of view of the virtual camera. A coordinate frame describes a 3D position and orientation of an object in a virtual experience. The coordinate frame is made up of a point in space and a set of three perpendicular directions called the axes (i.e., x, y, and z axes).

The position of the object is relative to a workspace, which is the location within the virtual experience. A virtual camera with a position of (0, 0, 0) is located at the origin of the workspace. A virtual camera with a position of (3, 5, −9) is displaced from the origin by three units along the x axis, five units along the y axis, and −9 units along the z axis, where negative numbers indicate that the object is backwards along the axis.

A CFrame is a property that encodes the position and orientation of a coordinate frame with respect to the workspace's coordinate frame. In some embodiments, the metaverse application 204 uses 12 numbers to describe the CFrame where the first three numbers describe the position of the origin of the CFrame, the next three numbers describe the direction vector of the x axis, the next three numbers describe the direction vector of the y axis, and the last three numbers describe the direction vector of the z axis. The vectors in a CFrame may be referred to as “Vector3.” A virtual camera positioned at the origin of the workspace may be described by the CFrame as: (0, 0, 0), (1, 0, 0), (0, 1, 0), (0, 0, 1), which means that the CFrame's origin is at the workspace origin, and its x, y, and z axes point parallel with the workspace's x, y, and z axes, respectively.

The metaverse application 204 determines a first position of a first avatar, a second position of a second avatar, and a midpoint between the first position and the second position. The metaverse application 204 determines an area direction that represents the position in 3D space of the physical bias direction part in the virtual experience. The metaverse application 204 determines a bias direction vector that starts at the area direction bias and continues through the midpoint.

The metaverse application 204 calculates an optionA vector from the first avatar to the second avatar and an optionB vector from the second avatar to the first avatar. An optionARotated vector is generated that is perpendicular to the optionA vector. An optionBRotated vector is generated that is perpendicular the optionB vector.

In some embodiments, the metaverse application 204 standardizes camera views by determining whether the first avatar or the second avatar is closer to the area direction bias. The avatar that is closest to the area direction bias is designated as the front subject position. The metaverse application 204 may determine the distance of the first avatar to the bias point, the distance of the second avatar to the bias point, and the avatar closest to the area direction bias position is selected as the front subject for determining the virtual camera perspective. For example, if the first avatar is closest to the area direction bias position, the metaverse application 204 may display a field of view that follows the movements of the first avatar primarily and the second avatar secondarily for a certain amount of time regardless of their positions. If the metaverse application 204 applied a distance parameter continually based on the distance of either the first avatar or the second avatar, a third player may experience dizziness and nausea as the virtual camera perspective repeatedly swapped between following the first avatar primarily or following the second avatar primarily.

The metaverse application 204 calculates a bias to front subject vector from the area direction bias to the closest avatar. The camera position is calculated by adding the bias to front subject vector to the optionARotated vector or the optionBRotated vector depending on whether a dot product between the optionARotated and the bias direction or the optionBRotated or the bias direction is bigger.

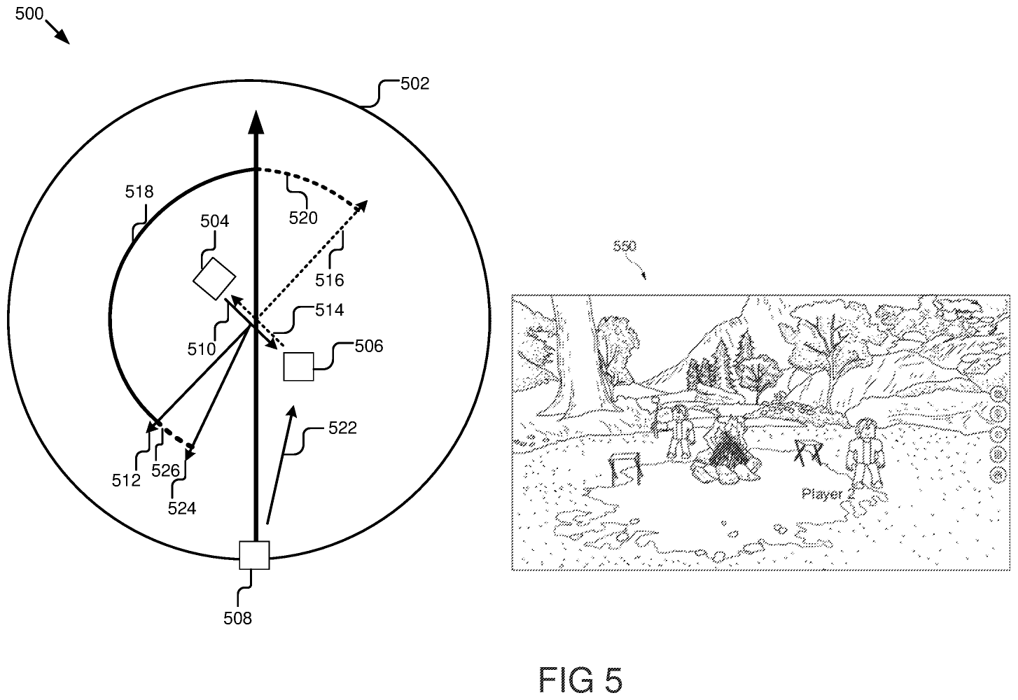

In some embodiments, the metaverse application 204 determines a camera position and direction of a virtual camera based on determining that a second avatar is the front subject. FIG. 5 includes an example diagram 500 used to determine the camera position and direction and a player perspective of a landscape front view 550 in cinematic mode. The virtual experience is defined by a boundary 502. The virtual experience includes a first avatar at a first position 504 and a second avatar at a second position 506. A bias direction 508 arrow is shown between the first avatar at the first position 504 and the second avatar at the second position 506 where the bias direction 508 is calculated as the vector between the area direction bias and the midpoint between the first position 504 and the second position 506.

OptionA 510 is a vector that is calculated from the difference between a normalized position of the first avatar and a normalized position of the second avatar. OptionARotated 512 is a vector that is based on the z value of optionA 510, the y value of optionA 510, and the negative x value of optionA 510. The optionARotated 512 vector is also perpendicular to optionA 510.

OptionB 514 is a vector that is calculated from the difference between a normalized position of the second avatar and a normalized position of the first avatar. OptionBRotated 516 is a vector that is based on the z value of optionB 514, the y value of optionB 514, and the negative x value of optionB 514. The optionBRotated 516 vector is also perpendicular to optionB 514.

In some embodiments, the metaverse application 204 generates a dot product for each vector option and the bias direction 508. Specifically, the A dot product 518 is a dot product of the optionARotated 512 vector and the bias direction 508 vector. The B dot product 520 is a dot product of the optionBRotated 516 vector and the bias direction 508 vector. If the A dot product 518 is less than the B dot product 520, the vector between subjects is the optionBRotated 516 vector plus the bias to front subject vector 522 (e.g., the calculation for which is described above). If the B dot product 520 is less than the A dot product 518, the vector between subjects is the optionARotated 512 vector plus the bias to front subject vector 522. In the example illustrated in FIG. 5, the A dot product 518 is larger than the B dot product 520 and, as a result, the camera direction 524 is the optionARotated 512 vector plus the bias to front subject vector 522. The bias to front subject vector 522 is also equivalent to the arc 526 next to the optionARotated 512 vector (and is also known as a bias offset), which results in the shift from the optionARotated 512 vector to the camera direction 524.

In some embodiments, the metaverse application 204 generates a camera position of the virtual camera based on the camera direction 524 using the following equation:

camera position=(mid position between the first avatar and the second avatar−(camera direction 524 vector*distance modifier)+a camera height offset) Eq. 1

where the distance modifier is the same as the vector between subjects (e.g., the optionARotated 512 vector in the example illustrated in FIG. 5 or the optionBRotated 516 vector in other scenarios). Using the equation results in a field of view that shows the player perspective of a landscape front view 550 in cinematic mode.

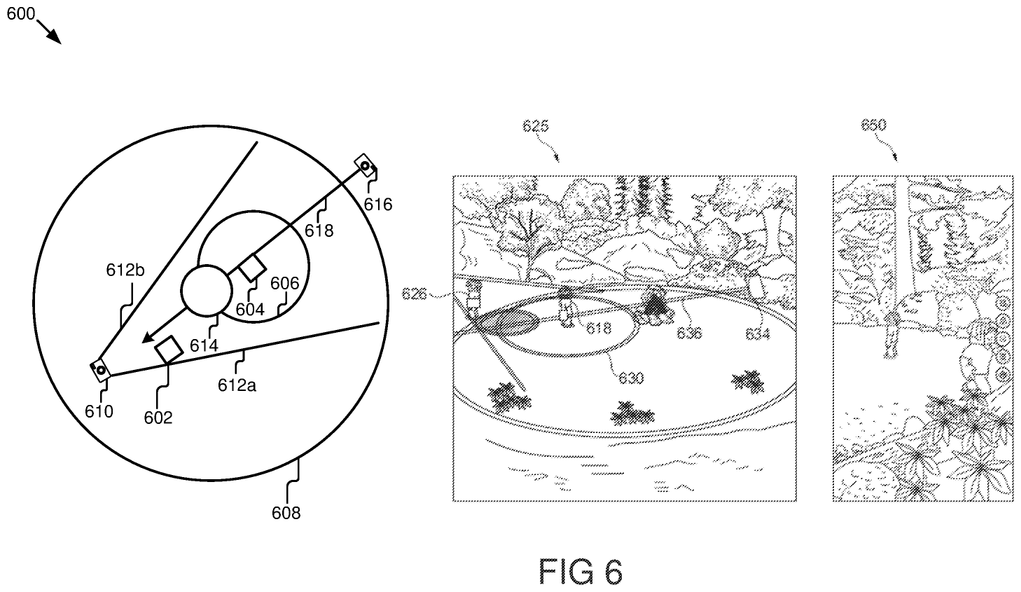

In some embodiments, transitioning from a shoulder view to a theater view may not result in a seamless transition between views if the player moves directly towards one of the avatars. In some embodiments, an issue arises when the viewport is in a portrait orientation and not in a landscape orientation. FIG. 6 includes example graphics of a diagram 600 of a virtual experience with a danger zone, a graphic 625 with portions of the diagram superimposed on the virtual experience, and a graphic 650 of a player perspective shoulder view in cinematic mode.

The diagram 600 includes a first position 602 of a first avatar and a second position 604 of a second avatar in shoulder view. The second avatar is within a first boundary 606. The outer circle is an environment boundary 608 that represents the part of the virtual experience that is visible as part of the field of view of the player.

The third position 610 of a virtual camera represents the location of the player within the virtual experience. The initial field of view 612a, 612b is represented by the lines emanating from the virtual camera.

In shoulder view, an offset is not used. Instead, the virtual camera generates a field of view that shows a shoulder of one of the avatars. However, an offset is used in the front view. The diagram 600 illustrates a danger zone 614 that demarcates an area where a transition between the shoulder view and the front view occurs and causes issues. The danger zone 614 arises when the player, which is represented as the third position 610 of the virtual camera, moves towards the second position 604 associated with the second avatar. The transition to front view results in the virtual camera having a camera position 616 with a bias direction 618 that is 180 degrees from the third position 610 of the virtual camera. If the metaverse application 204 transitioned from the shoulder view to the front view, the virtual camera would display the field of view as if the player performed a flip, which may cause the player to experience nausea and dizziness.

In some embodiments, the metaverse application 204 prevents this situation from occurring by delaying a transition from the shoulder view to the front view until the player is stationary. In another example, the metaverse application 204 may modify parameters that trigger the transition to avoid the scenario.

The graphic 625 includes portions of the diagram superimposed on the virtual experience. For example, the portions include the first position 626 of the first avatar, the second position of the second avatar 628, the first boundary 630, the environment boundary 632, the camera position 634 of the virtual camera, and the bias direction 636.

The graphic 650 of a player perspective shoulder view in cinematic mode is an example of how the virtual experience appears before the metaverse application 204 transitions from the shoulder view to a front view.

The metaverse application 204 may determine different directions and positions for the virtual camera in the shoulder view. For example, the metaverse application 204 may construct a CFrame for the shoulder view that determines length for a shoulder view vector based on a distance from the shoulder of a first avatar to the virtual camera and subtracts the length from the position of the first avatar. The subtracted value is then offset vertically based on the virtual camera height offset value, where the value is particular to the shoulder view.

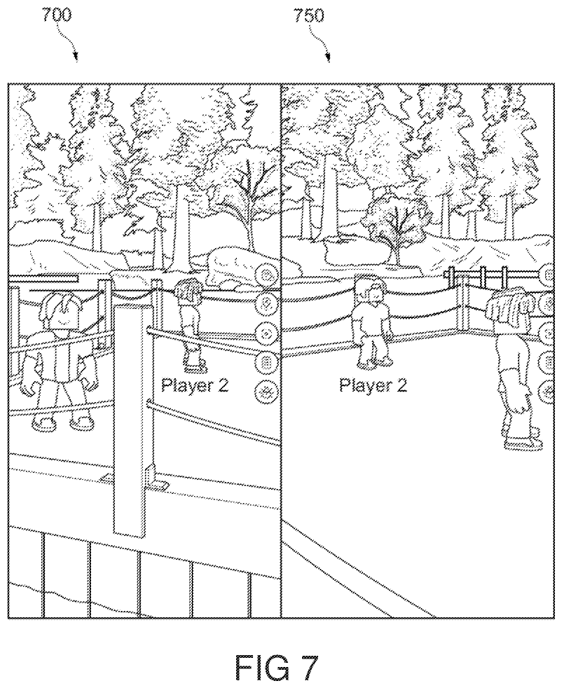

In some embodiments, the metaverse application 204 determines a right offset position and a left offset position for the virtual camera and selects either the right offset position or the left offset position based on the position that is closest to the area direction bias. The selected offset position may be used for the offset shoulder view. FIG. 7 includes an example graphic 700 of a shoulder view with a right offset as compared to a graphic 750 that illustrates a shoulder view with a left offset.

In some embodiments, the metaverse application 204 transitions between different perspectives, such as a close-up perspective, a medium perspective, and a wide-angle perspective. For example, when the player walks towards an avatar, the metaverse application 204 transitions from a medium perspective to a close-up perspective when a distance between the player and an avatar is below a threshold distance. In some embodiments, the transition between different perspectives occurs slowly to reduce dizziness that may occur when changing perspectives. In some embodiments, the graphic 450 in FIG. 4 includes a wide-angle perspective.

In some embodiments, the metaverse application 204 transitions between a front view and a shoulder view (or a shoulder view and a front view) based on a distance between a position of a player and a position of an avatar. For example, the metaverse application 204 may determine that a distance between the virtual camera and a first avatar is below a distance threshold and in response to the determining, updates the field of view based on a subsequent position of the virtual camera.

In some embodiments, the metaverse application 204 transitions between views based on a shoulder weight. The metaverse application 204 may determine the shoulder weight based on a predetermined weight and a viewport aspect ratio. The metaverse application 204 may apply an easing function to create a smooth transition over time that employs the shoulder weight by determining a current time or a progress variable, a start value, a change in the start value, and a duration of the transition. If the current time is 0, the start value is returned. Otherwise, an exponentially increasing value is calculated based on the progress of time over the duration of the transition.

The predetermined weight may be based on a camera direction parameter that is a ratio of a difference between a maximum distance threshold and a distance between the virtual camera and the first avatar and the maximum distance threshold. The viewport aspect ratio indicates whether the display has a portrait orientation or a landscape orientation. If the viewport aspect ratio is less than or equal to 1, which indicates that the viewport aspect ratio is not in a portrait orientation, the shoulder view weight may default to 0.

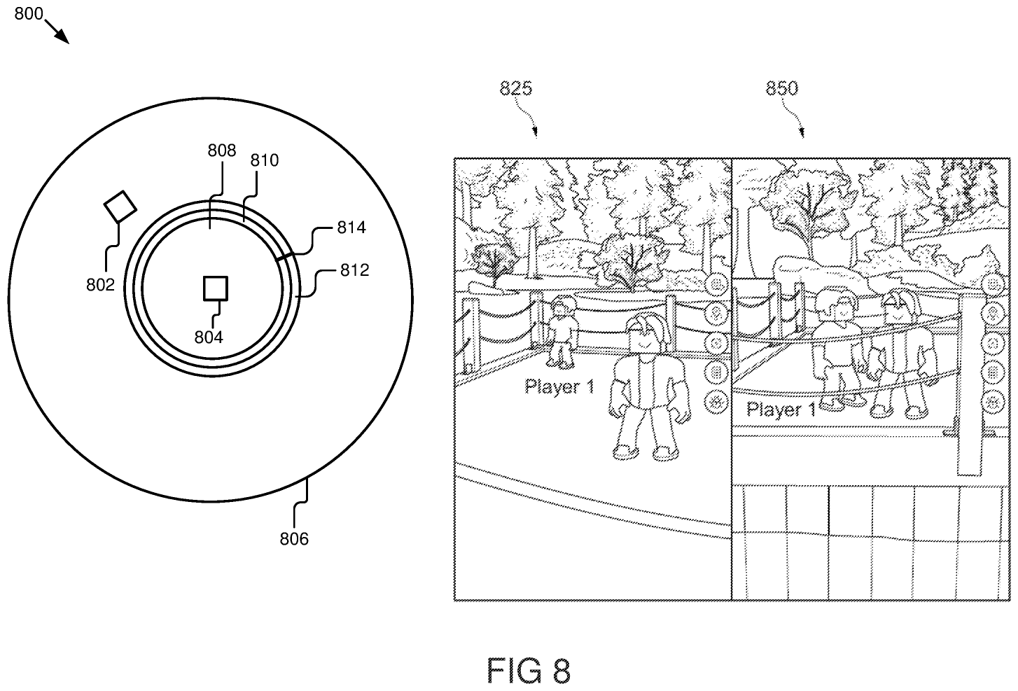

FIG. 8 includes an example diagram 800 of shoulder view parameters in a virtual experience and graphics of corresponding shoulder views as a function of weight. The diagram 800 includes a first position 802 of a first avatar and a second position of a second avatar. The virtual experience is contained within a boundary 806.

The shoulder view weight determines how much the view is biased towards the shoulder view. The shoulder view weight may be 1 808, 0.5 810, or 0 812. If the shoulder view weight is 1, the metaverse application 204 generates a shoulder view. If the shoulder view weight is 0, the metaverse application 204 generates a front view. If the shoulder view weight is 0.5, the metaverse application 204 generates a 50/50 blended view of the front view and the shoulder view.

A first graphic 825 illustrates the shoulder view where the shoulder view weight is 1 and a second graphic 850 illustrates the front view where the weight is 0.

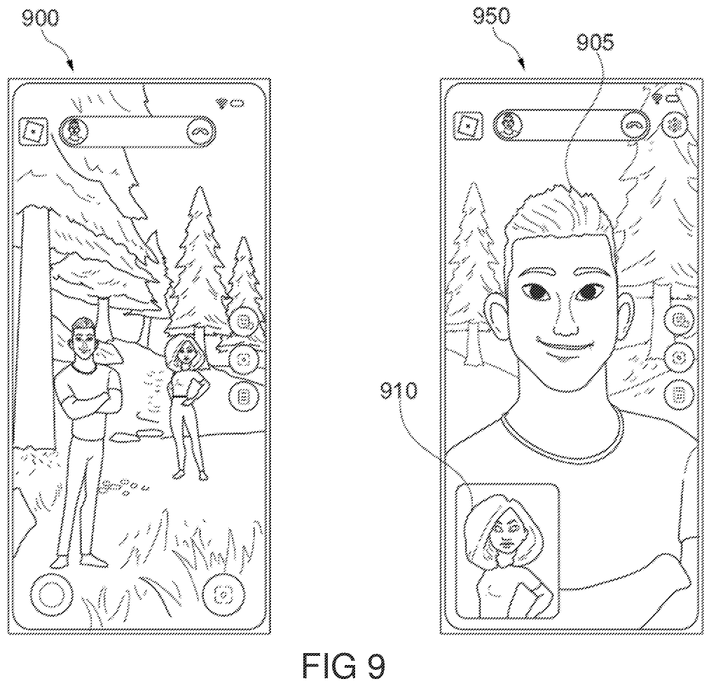

In some embodiments, the metaverse application 204 transitions between different modes. For example, the metaverse application 204 may transition from a cinematic mode to a picture-in-picture mode. The picture-in-picture mode may be used during a virtual phone call where a player calls another player within the virtual experience. The picture-in-picture mode displays the avatar that the player called as well as an image of the player's avatar. FIG. 9 includes an example graphic 900 of a cinematic mode and an example graphic 950 a picture-in-picture mode with the avatar 905 that the player called as well as an avatar 910 of the player.

In some embodiments, the metaverse application 204 uses different virtual springs to simulate movement with the virtual camera. For example, the metaverse application 204 may use a virtual spring to change a position of a player, a virtual spring to change a direction and rotation of a player, and/or a virtual spring to change a field of view for the player.

In some embodiments, the metaverse application 204 smoothly transitions between different modes by determining a start CFrame associated with a current mode and an end CFrame associated with a different mode. The metaverse application 204 may align the position and rotation of the start CFrame with the position and rotation of the end CFrame and interpolate between the start CFrame and the end CFrame.

The metaverse application 204 may use a Catmull-Rom Spline to interpolate between a series of points. The metaverse application 204 may determine a start position, a middle position, and an end position. For example, the metaverse application 204 may determine the middle position by creating a Bezier curve using the start position and the end position and identify the location of the middle position along the Bezier curve.

The metaverse application 204 may further determine a first middle point that is offset from a middle position in the direction of a right vector from a start to end CFrame and a second middle point that is offset from the middle position in the direction of a negative right vector. The amount of offset may be determined by a distance between the starting point and the end point and a chosen division factor.

The metaverse application 204 may select either the first middle point or the second middle point based on the one that is farther from the middle position of the player. As the transition progresses, the metaverse application 204 may update the position of the virtual camera along the spline and direction. The metaverse application 204 may also continuously perform a linear interpolation of the end point of the spline to account for changes in the initial start position and direction of the different mode that the metaverse application 204 transitions to from the current mode. In some embodiments, when the distance between a current position and a target position falls below a threshold value that indicates that the player is close to the destination, the metaverse application 204 performs a linear interpolation between the current position and the target position.

In some embodiments, the metaverse application 204 determines a CFrame for the player, determines a position and rotation values from the CFrame, and uses the values as an initial position and initial rotation values for the virtual spring. In some embodiments, the metaverse application 204 uses Hooke's law to determine the behavior of the virtual spring. Depending on the type of spring, the metaverse application 204 may modify one or more of the virtual spring's position, velocity, target, damper, speed, and/or synchronization clock.

In some embodiments, the metaverse application 204 simulates motion of the virtual camera based on the virtual spring moving from the initial position to a target position, the target position being based on movement of the first avatar and the second avatar. The virtual spring may be configured to simulate a dampening of movement of the virtual camera and a speed of rotation of the virtual camera. For example, the dampening may be set to 1 and the speed may be set to 5. The speed range may be between 0 and infinity. The dampening may stay close to 1 where anything below 1 is underdamped, causing bouncing, and anything above 1 is critically damped.

In some embodiments, the metaverse application 204 simulates rotation of the virtual camera based on the virtual spring from an initial direction to a target direction while keeping the first avatar and the second avatar visible in the field of view. The virtual spring may be configured to simulate a dampening of movement of the virtual camera and a speed of rotation of the virtual camera. For example, the dampening may be set to 1 and the speed may be set to 4.

In some embodiments, the metaverse application 204 simulates motion of the virtual camera based on the virtual spring to change a field of view of the virtual camera. The virtual spring may be configured to simulate a dampening of movement of the virtual camera and a speed of rotation of the virtual camera. For example, the dampening may be set to 2 and the speed may be set to 0.5, which results in a slower speed for field-of-view changes as compared to positional changes.

In some embodiments, the metaverse application 204 determines whether one or more springs should be used as part of the virtual camera's CFrame. The metaverse application 204 may make this determination when determining a CFrame for a target position or when the metaverse application 204 compares a target CFrame that uses a spring to a CFrame that is a rigid target. If a spring is used, the metaverse application 204 may determine that the target direction of the spring is the same as the direction of the virtual camera and the target field of view of the spring is based on a shoulder view weight and half the distance between subjects.

The metaverse application 204 may determine a target CFrame based on a position of the virtual camera, a direction of the virtual camera and one or more of a shoulder view weight, a distance between a first avatar and a second avatar, a goal position for the virtual camera, a middle position between the first avatar and the second avatar, and a direction of the spring. In some embodiments, the metaverse application 204 determines a distance between the virtual camera and the first avatar (or the second avatar) and if the distance is greater than a camera distance threshold, the metaverse application 204 may determine a CFrame for a camera position that is closer to the first avatar and/or the second avatar. Depending on the camera distance threshold, the metaverse application 204 may use a CFrame with a camera position that results in the virtual camera rapidly moving closer to the players to avoid a long transition to the target CFrame if the first avatar and/or the second avatar unexpectedly move between large distances. If the distance between the virtual camera and the first avatar (or the second avatar) is less than the camera distance threshold, the metaverse application 204 may determine a CFrame that is based on the virtual camera position and the middle position and the transition may occur more slowly than in the previous scenario.

### Example Method

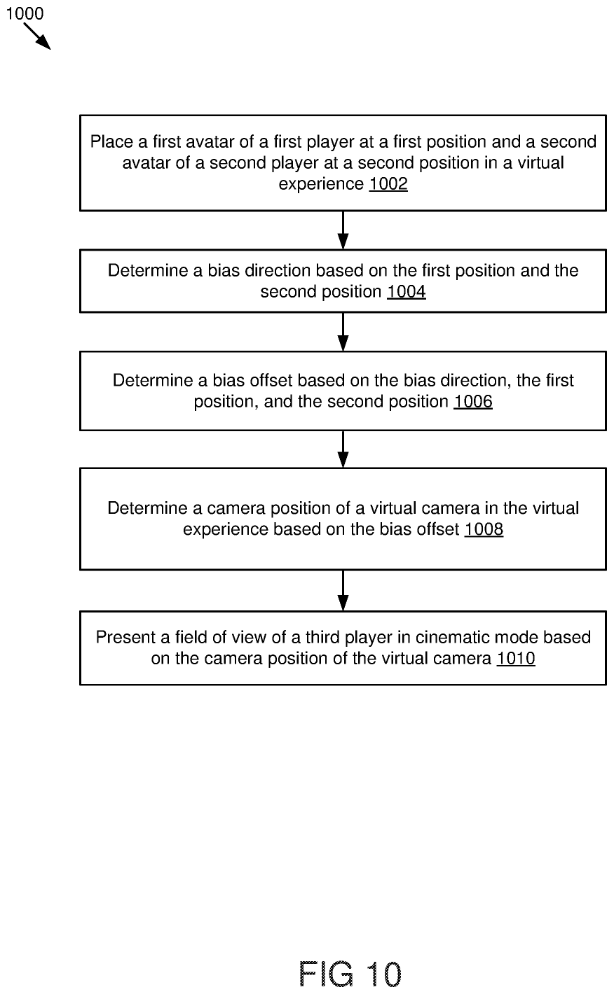

FIG. 10 is a flow diagram of an example method to determine a field of view of a player in cinematic mode in a virtual experience. In some embodiments, all or portions of the method 1000 are performed by the metaverse application 204 stored on the server 201 as illustrated in FIG. 2 and/or the metaverse application 204 stored on the computing device 300 of FIG. 3.

The method 1000 may begin with block 1002. At block 1002, a first avatar is placed at a first position and a second avatar of a second player at a second position in a virtual experience. In some embodiments, prior to presenting the field of view in the cinematic mode, graphical data of a user interface is generated that includes a button that, when selected, causes the virtual experience to be displayed in the cinematic mode. Block 1002 may be followed by block 1004.

At block 1004, a bias direction is determined based on the first position and the second position. Block 1004 may be followed by block 1006.

At block 1006, a bias offset is determined based on the bias direction, the first position, and the second position. In some embodiments, determining the bias offset is further based on a first vector between the first position and the second position, a second vector that is perpendicular to the first vector, and an addition of a bias to front subject vector to the second vector. Block 1006 may be followed by block 1008.

At block 1008, a camera position of a virtual camera in the virtual experience is determined based on the bias offset. Block 1008 is followed by block 1010.

At block 1010, a field of view of a third player is presented in cinematic mode based on the camera position of the virtual camera.

In some embodiments, the method may further include determining that a distance between the virtual camera and the first avatar is below a distance threshold and in response to the determining, updating the field of view based on a fourth position of the virtual camera, wherein the field of view switches from capturing a front view to a shoulder view that captures the first avatar and the second avatar from a perspective of being over a shoulder of the third player. Updating the field of view may be further based on a weight, where the weight is based on a ration of a difference between a maximum distance threshold and a distance between the virtual camera and the first avatar and the maximum distance threshold. Updating the field of view to switch from capturing the front view to the shoulder view may be further based on a shoulder view weight that is based on the weight and an aspect ratio of the virtual camera.

In some embodiments, the method may further include determining to transition from the cinematic mode to a second mode, such as a picture-in-picture mode. A start frame associated with the cinematic mode may be determined, an end frame associated with the second mode may be determined, and interpolation may occur between the start frame and the end frame. For example, the interpolating may include interpolating between a position of the start frame and a position of the end frame by applying a Catmull-Rom spline.

In some embodiments, the method further includes using virtual springs where an initial position and initial rotation values are set for a virtual spring that is associated with the virtual camera. Motion of the virtual camera may be simulated based on the virtual spring moving from the initial position to a target position, the target position being based on movement of the first avatar and the second avatar, wherein the virtual spring is configured to simulate a dampening of movement of the virtual camera and a speed of rotation of the virtual camera. . . . Rotation of the virtual camera may be simulated based on the virtual spring from an initial direction to a target direction while keeping the first avatar and the second avatar visible in the field of view, wherein the virtual spring is configured to simulate a dampening of movement of the virtual camera and a speed of rotation of the virtual camera. In some embodiments, responsive to determining that, after movement of the first avatar within the virtual experience, a distance between the camera position of the virtual camera and a third position associated with the first avatar exceeds a distance threshold, presenting the field of view of the third player based on an updated position of the virtual camera, wherein a distance between the updated position and the third position is less than a distance between the camera position and the third position.

While the foregoing description refers to a first avatar that is blocked by a user, it will be appreciated that a virtual experience may include any number of avatars, with each avatar blocking zero, one, or more other avatars. For each avatar, respective additional audio is generated (e.g., locally on the user device of the user associated with the avatar) to block out audio from the corresponding blocked avatars. In some embodiments, e.g., if a user blocks three avatars at different locations, three distinct portions of additional audio may be generated, each corresponding to a particular blocked avatar. In some embodiments, if two or more blocked avatars are co-located (at or near a same location), a single portion of additional audio may be generated corresponding to the two or more blocked avatars.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various embodiments. In some embodiments, blocks and operations can be performed multiple times, in a different order, and/or at different times in the methods.

Various embodiments described herein include obtaining data from various sensors in a physical environment, analyzing such data, generating recommendations, and providing user interfaces. Data collection is performed only with specific user permission and in compliance with applicable regulations. The data are stored in compliance with applicable regulations, including anonymizing or otherwise modifying data to protect user privacy. Users are provided clear information about data collection, storage, and use, and are provided options to select the types of data that may be collected, stored, and utilized. Further, users control the devices where the data may be stored (e.g., user device only; client+server device; etc.) and where the data analysis is performed (e.g., user device only; client+server device; etc.). Data are utilized for the specific purposes as described herein. No data is shared with third parties without express user permission.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one embodiments of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMS, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method to determine a field of view of a player in cinematic mode in a virtual experience, the method comprising:
placing a first avatar of a first player at a first position and a second avatar of a second player at a second position in a virtual experience;
determining a bias direction based on the first position and the second position;
determining a bias offset based on the bias direction, the first position, and the second position;
determining a camera position of a virtual camera in the virtual experience based on the bias offset; and
presenting a field of view of a third player in cinematic mode based on the camera position of the virtual camera.

2. The method of claim 1, wherein determining the bias offset is further based on a first vector between the first position and the second position, a second vector that is perpendicular to the first vector, and an addition of a bias to front subject vector to the second vector.

3. The method of claim 1, further comprising:
determining that a distance between the virtual camera and the first avatar is below a distance threshold; and
in response to the determining, updating the field of view based on a fourth position of the virtual camera, wherein the field of view switches from capturing a front view to a shoulder view that captures the first avatar and the second avatar from a perspective of being over a shoulder of the third player.

4. The method of claim 3, wherein updating the field of view to switch from capturing the front view to the shoulder view is further based on a weight, wherein the weight is based on a ratio of:
a difference between a maximum distance threshold and a distance between the virtual camera and the first avatar; and
the maximum distance threshold.

5. The method of claim 4, wherein updating the field of view to switch from capturing the front view to the shoulder view is further based on a shoulder view weight that is based on the weight and an aspect ratio of the virtual camera.

6. The method of claim 1, further comprising:
determining to transition from the cinematic mode to a second mode; and
determining a start frame associated with the cinematic mode, an end frame associated with the second mode, and interpolating between the start frame and the end frame.

7. The method of claim 6, wherein interpolating between a position of the start frame and a position of the end frame includes applying a Catmull-Rom spline.

8. The method of claim 1, further comprising:
setting an initial position and initial rotation values for a virtual spring that is associated with the virtual camera; and
simulating motion of the virtual camera based on the virtual spring moving from the initial position to a target position, the target position being based on movement of the first avatar and the second avatar, wherein the virtual spring is configured to simulate a dampening of movement of the virtual camera and a speed of rotation of the virtual camera.

9. The method of claim 1, further comprising:
setting an initial position and initial rotation values for a virtual spring that is associated with the virtual camera; and
simulating rotation of the virtual camera based on the virtual spring from an initial direction to a target direction while keeping the first avatar and the second avatar visible in the field of view, wherein the virtual spring is configured to simulate a dampening of movement of the virtual camera and a speed of rotation of the virtual camera.

10. The method of claim 1, further comprising:
setting an initial position and initial rotation values for a virtual spring that is associated with the virtual camera; and
simulating motion of the virtual camera based on the virtual spring to change a field of view of the virtual camera, wherein the virtual spring is configured to simulate a dampening of movement of the virtual camera and a speed of rotation of the virtual camera.

11. The method of claim 10, further comprising:
responsive to determining that, after movement of the first avatar within the virtual experience, a distance between the camera position of the virtual camera and a third position associated with the first avatar exceeds a distance threshold, presenting the field of view of the third player based on an updated position of the virtual camera, wherein a distance between the updated position and the third position is less than a distance between the camera position and the third position.

12. The method of claim 1, further comprising prior to presenting the field of view in the cinematic mode, generating graphical data of a user interface that includes a button that, when selected, causes the virtual experience to be displayed in the cinematic mode.

13. A system comprising:
a processor; and
a memory coupled to the processor, with instructions stored thereon that, when executed by the processor, cause the processor to perform operations comprising:
placing a first avatar of a first player at a first position and a second avatar of a second player at a second position in a virtual experience;
determining a bias direction based on the first position and the second position;
determining a bias offset based on the bias direction, the first position, and the second position;
determining a camera position of a virtual camera in the virtual experience based on the bias offset; and
presenting a field of view of a third player in cinematic mode based on the camera position of the virtual camera.

14. The system of claim 13, wherein the operations further comprise:
determining that a distance between the virtual camera and the first avatar is below a distance threshold; and
in response to the determining, updating the field of view based on a fourth position of the virtual camera, wherein the field of view switches from capturing a front view to a shoulder view that captures the first avatar and the second avatar from a perspective of being over a shoulder of the third player.

15. The system of claim 13, wherein the operations further comprise:
determining to transition from the cinematic mode to a second mode; and
determining a start frame associated with the cinematic mode, an end frame associated with the second mode, and interpolating between the start frame and the end frame.

16. The system of claim 13, wherein the operations further comprise:
setting an initial position and initial rotation values for a virtual spring that is associated with the virtual camera; and
simulating motion of the virtual camera based on the virtual spring moving from the initial position to a target position, the target position being based on movement of the first avatar and the second avatar, wherein the virtual spring is configured to simulate a dampening of movement of the virtual camera and a speed of rotation of the virtual camera.

17. A non-transitory computer-readable medium with instructions that, when executed by one or more processors at a computing device, cause the one or more processors to perform operations, the operations comprising:
placing a first avatar of a first player at a first position and a second avatar of a second player at a second position in a virtual experience;
determining a bias direction based on the first position and the second position;
determining a bias offset based on the bias direction, the first position, and the second position;
determining a camera position of a virtual camera in the virtual experience based on the bias offset; and
presenting a field of view of a third player in cinematic mode based on the camera position of the virtual camera.

18. The computer-readable medium of claim 17, wherein the operations further comprise:
determining that a distance between the virtual camera and the first avatar is below a distance threshold; and
in response to the determining, updating the field of view based on a fourth position of the virtual camera, wherein the field of view switches from capturing a front view to a shoulder view that captures the first avatar and the second avatar from a perspective of being over a shoulder of the third player.

19. The computer-readable medium of claim 17, wherein the operations further comprise:
determining to transition from the cinematic mode to a second mode; and
determining a start frame associated with the cinematic mode, an end frame associated with the second mode, and interpolating between the start frame and the end frame.

20. The computer-readable medium of claim 17, wherein the operations further comprise:
setting an initial position and initial rotation values for a virtual spring that is associated with the virtual camera; and
simulating motion of the virtual camera based on the virtual spring moving from the initial position to a target position, the target position being based on movement of the first avatar and the second avatar, wherein the virtual spring is configured to simulate a dampening of movement of the virtual camera and a speed of rotation of the virtual camera.
